(19) United States
(12) Patent Application Publication
(10) Pub. No.: US 2008/0218747 A1
(43) Pub. Date: Sep. 11, 2008

(54) Method and Apparatus for Detecting Surface Characteristics on a Mask Blank

(76) Inventor: Stanley E. Stokowski, Danville, CA (US)

Correspondence Address: DAVIS WRIGHT TREMAINE LLP - KLA-TENCOR CORPORATION, 505 MONTGOMERY STREET, SUITE 800, SAN FRANCISCO, CA, 94111-6533, US

(21) Appl. No.: 12/126,771

(22) Filed: May 23, 2008

Related U.S. Application Data
(62) Division of application No. 11/127,436, filed on May 11, 2005.
(60) Provisional application No. 60/570,875, filed on May 12, 2004.

(51) Int. Cl. G01N 21/00

(52) U.S. Cl. 356/73

(57) ABSTRACT

An optical system and method configured to detect surface height variations on a mask blank. The optical system comprises a Wollaston prism, optics and first and second detectors. The Wollaston prism splits an incident beam of radiation into a first beam and a second beam. The first beam has a first polarization. The second beam has a second polarization. The optics directs the first and second beams along first and second paths onto first and second illuminated areas on a surface of the mask blank. The first and second illuminated areas reflect or transmit portions of the first and second beams to produce first and second reflected or transmitted beams. The first and second detectors detect the first and second reflected or transmitted beams and produce first and second signals in response to the first and second reflected or transmitted beams. A multiple way coupler may also be used for detecting height variation or other features on a mask blank. Two substantially parallel optical incident radiation beams are transmitted to the mask blank. The multiple way coupler mixes portions of the two beams after they have been reflected or transmitted by two different areas of said mask blank to provide three or more outputs which can be analyzed to provide information on height variation or other features on the mask blank.

### CROSS-REFERENCE TO RELATED APPLICATIONS

This application is a divisional of application Ser. No. 11/127,436 filed on May 11, 2005, which claims benefit of U.S. Provisional Application No. 60/570,875 filed May 12, 2004, which applications are incorporated herein in their entirety by this reference.

### BACKGROUND OF THE INVENTION

1. Field of the Invention

The present invention relates to lithographic mask fabrication, and more particularly, to detecting surface characteristics such as defects and height variations on a mask blank.

2. Description of the Related Art

In lithography, a patterned mask is used to expose selected areas of a substrate or wafer covered by a photoresist to radiation for subsequent etching. Mask blanks are unpatterned masks which will later be patterned and used in lithography.

The semiconductor manufacturing industry estimates that, at the present state of the art, a desirable defect monitoring tool may detect a surface defect of 60 nm in diameter and 1.5 nm high on an object, such as a mask blank or unpatterned mask. Very low-profile defects are extremely difficult to detect by conventional bright-field and dark-field inspection techniques. For dark-field field inspection techniques, the absence of a significant edge for these small defects results in a very small signal, which may be unusable.

### SUMMARY OF THE INVENTION

A method and apparatus to detect and measure surface characteristics (e.g. height variations or other defects) on a mask blank are provided in accordance with the present invention. In one embodiment, the apparatus uses a bright field, differential interference contrast (DIC) technique (also called the Nomarski technique) to detect and measure low-profile surface height variations, i.e., defects or anomalies, on a mask blank. The DIC technique is extremely sensitive in detecting and measuring small surface variations (also called topography detection and characterization). Specifically, the DIC technique is extremely sensitive in detecting small phase differences of two light beams reflected or transmitted by two small areas of a surface.

In one embodiment, two substantially parallel optical beams are transmitted to a mask blank at an inspection station where the beams are initially coherent but of different polarizations. A detector detects any phase shift between portions of the two incident beams that are reflected or transmitted by the mask blank to determine height variation on the mask blank. Preferably, an instrument is used to handle the mask blank and to transport the mask blank to and from the inspection station.

In one implementation of the above embodiment, a Wollaston prism may be used to separate a laser beam into two beams having different polarizations. In the implementation where the two incident beams are normal to the surface of the mask blank, the Wollaston prism may also be employed to collect the reflected portions of the two beams, combine the two reflected portions into one beam and direct such beam to the detector.

According to another aspect of the invention, a multiple way coupler may be used for detecting height variation or other features on a mask blank. Two substantially parallel optical incident radiation beams are transmitted to the mask blank. The multiple way coupler mixes portions of the two beams after they have been reflected or transmitted by two different areas of said mask blank to provide three or more outputs which can be analyzed to provide information on height variation or other features on the mask blank.

### BRIEF DESCRIPTION OF THE DRAWINGS

FIG. 1 illustrates one embodiment of a surface scanning system for bright field and dark field radiation detection.

FIG. 2A illustrates one embodiment of a system in accordance with the present invention that is configured to detect height variations on a surface of an object.

FIG. 2B illustrates a subset of the components in FIG. 2A and some additional components.

FIG. 3 illustrates a vector graph of a polarizing beam splitter in FIGS. 2A and 2B.

FIG. 4 illustrates an example of two beams scanning a surface of an object that has a height variation.

FIG. 5 illustrates a plot of surface height change (Δh) on the x-axis and differential interference contrast (DIC) signal strength intensity change (ΔI) on the y-axis.

FIG. 6 illustrates a Wollaston prism in the system of FIG. 2A that generates beams of light to detect examples of height variations on a surface of an object.

FIG. 7 is a schematic cross-sectional view at some point along the length of a fiber optical tri-coupler such as used in a interferometer for measuring an object to illustrate an alternative embodiment of the invention.

FIG. 8 is a schematic of an interferometer of the alternative embodiment the present invention illustrated in FIG. 7.

FIG. 9 is a schematic of yet another alternate embodiment of an interferometer of the present invention;

FIG. 10 is a graph showing the output signals from photodetectors on the interferometer versus the input phase-difference between the input beams to illustrate the alternative embodiments of FIGS. 7-9.

For simplicity in description, identical components are identified by the same numerals in this application.

### DETAILED DESCRIPTION

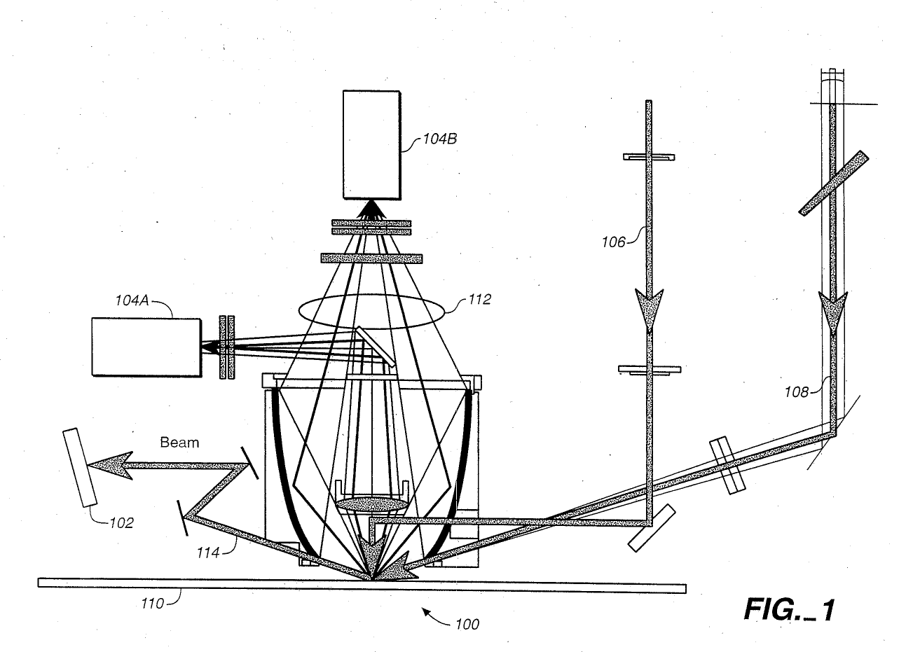

FIG. 1 illustrates one embodiment of a surface scanning system 100 for bright field (BF) and dark field (DF) radiation detection. The scanning system 100 comprises a normal incidence light/radiation beam 106, an oblique incidence light beam 108, a surface 110, a dark field radiation sensor 104A, another dark field radiation sensor 104B and a bright field radiation sensor 102. The sensors 102, 104A, 104B may comprise transducers, detectors, collectors, charge-coupled devices (CCDs) or other types of radiation sensors.

Dark field detection refers to the collection and registration of scattered radiation 112 from the surface 110. Dark field detection is sensitive to small defects and sharp edges. Dark field techniques may be very effective for revealing particles and other types of efficient light scatterers on the surface 110. But some surface topography, such as large, shallow defects or dimples, and some crystallographic defects, such as slip lines and stacking faults, cause locally strong gradient and may not scatter light efficiently.

Bright field detection refers to operations performed on reflected radiation 114 from the surface 110. Bright field detection is sensitive to variations (e.g., slope) over the surface 110. Various aspects of reflected light 114 may reveal information about the surface 110. For example, an intensity of reflected light 114 may reveal surface material information but may not reveal surface topography information. A phase of reflected light 114 may reveal surface topography and material information. A direction of reflected light 114 may reveal surface topography information.

One embodiment of the invention is implemented in a bright field scanning spot system with a Wollaston prism (described below) in the optical objective to produce and then recombine two spots reflected from an inspected surface of an object or material. In one embodiment, the scanning spot system is a modified, unpatterned wafer inspection system. One example of an unpatterned wafer inspection system is Surfscan SP1 made by KLA Tencor Corporation in San Jose, Calif. The Surfscan SP1 system has been described in co-assigned U.S. Pat. Nos. 6,271,916 and 6,201,601, which are hereby incorporated by reference in their entireties. In one embodiment, the unpatterned wafer inspection system is modified to inspect mask blanks by reducing the size of illuminated spots on a surface and reducing the separation of the spots compared to surface features of the sample. Thus, the modified system may have a higher resolution and detect smaller surface height variations.

Another example of a scanning spot system is a RAPID division Fx7 series being developed by KLA Tencor.

Another embodiment of the invention uses a modified imaging system or a reticle inspection system, such as the TeraScan 570 system being developed by KLA-Tencor. The TeraScan 570 system is described in “Reticle inspection system using DUV wavelength and new algorithm platform for advanced reticle inspection for 0.13-?m technology node”, David S. Alles, Paul Terbeek, Shauh-Teh Juang, James N. Wiley, Kangmin Hsia, Proc. SPIE Vol. 4066, p. 462-471, Photomask and Next-Generation Lithography Mask Technology VII; Hiroaki Morimoto; Ed., July 2000. This article is incorporated by reference.

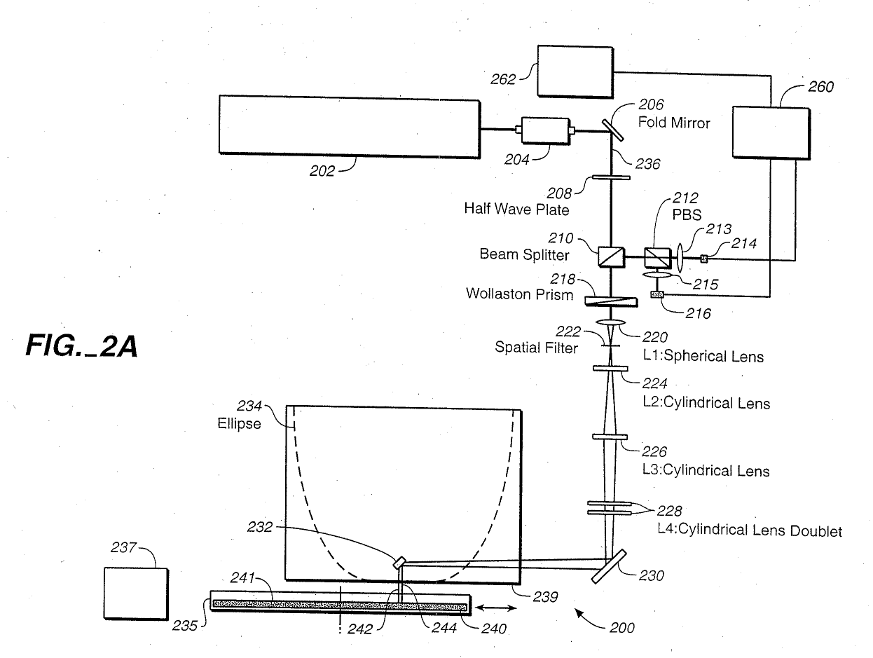

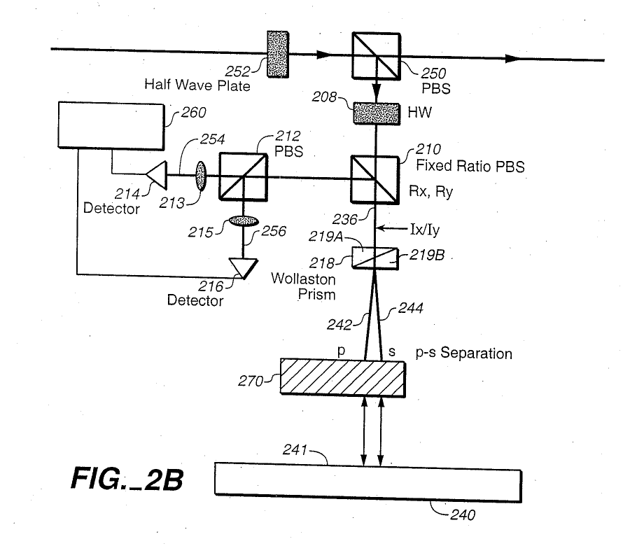

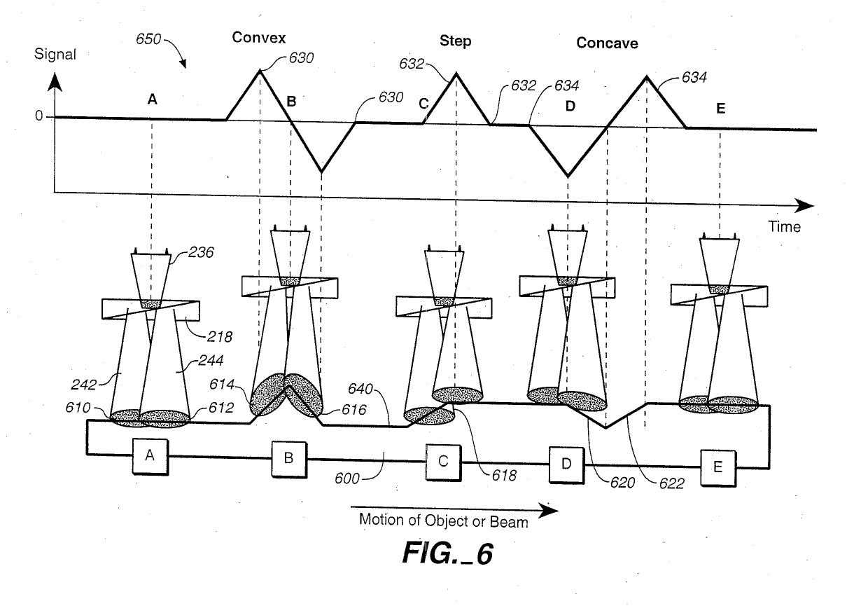

FIG. 2A illustrates one embodiment of a system 200 in accordance with the present invention that is configured to detect height variations on a surface 241 of an object 240. The system 200 comprises a radiation light source 202, an isolator 204, a fold mirror 206, a half wave plate 208, a beam splitter (BS) 210, a polarizing beam splitter (PBS) 212, lenses 213, 215, detectors 214, 216, a Wollaston prism 218, a spherical lens 220, a spatial filter 222, a cylindrical lens 224, a cylindrical lens 226, a cylindrical lens doublet 228, a mirror 230, a mirror 232, an ellipsoidal collector 234 and a signal processor 260. Some of the components in FIG. 2A are described in co-assigned U.S. Pat. Nos. 6,271,916 (e.g., see FIGS. 6, 7 and 9) and 6,201,601, which have been incorporated by reference. In one embodiment, object 240 is a mask blank, which is held in a frame 235 at inspection station shown in FIG. 2A. A handler or gripper 237 moves the mask blank by gripping frame 235 and moving the frame along arrow 239 towards the inspection station where the mask blank is positioned as shown in FIG. 2A for inspection as described herein. After inspection is completed, handler or gripper 237 moves the frame and mask blank therein away from the station. The handler or gripper 237 is available commercially, and may be controlled to operate as described above in a conventional manner known to those skilled in the art.

Other embodiments of the system 200 may comprise other components in addition to or instead of the components illustrated in FIG. 2A. Alternatively, other embodiments of the system 200 may comprise only some of the components shown in FIG. 2A. For example, other embodiments of the system 200 may have additional lenses or optical elements or only some of the lenses or optical elements in FIG. 2A.

In one embodiment, the light source 202 in FIG. 2A comprises a 0.488-micrometer argon gas laser. In other embodiments, other types of lasers or radiation sources may be used. The detectors 214, 216 in FIG. 2A may comprise transducers, collectors, charge-coupled devices (CCDs) or other types of radiation sensors.

The mirrors 206, 230, 232 may comprise any type of device configured to reflect or direct a beam of radiation in a desired direction.

In one embodiment, the object 240 in FIG. 2A may comprise a multi-layer object, such as a mask blank, which has not been patterned yet for use in lithography. For example, the object 240 may be a reflective mask blank. The object 240 may be a multi-layer mask blank. Specifically, the object 240 may be an extreme ultraviolet (EUV) reflective, multi-layer mask blank.

In one configuration, the reflective mask blank comprises about 40 pairs of Mo/Si layers. A vacuum sputtering technique may deposit the layers on a silicon or a low-thermal expansion substrate. Ideally, the deposition process should not introduce any defects in the multi-layer mask blank. A defect in the multi-layer mask blank may produce a distortion within the layers and a small bump or dimple on the mask blank's surface. This type of defect may result in an unacceptable mask blank that is patterned and used in EUV lithography to create defective printed wafers.

In general, the system 200 in FIG. 2A is configured to project two light beams 242, 244 with substantially similar optical paths on two adjacent spots 610, 612 (FIG. 6) on a surface 241. The surface 241 reflects the two light beams 242, 244. The phase difference between two reflected light beams may reveal height or tangential slope information about the surface 241. The object 240 may be moved horizontally for the system 200 to analyze various parts of the surface 241. The system 200 uses a differential interference contrast (DIC) technique (also called the Nomarski technique) to detect and measure low-profile (small-height) surface variations or defects on the surface 241 of the object 240 (see FIGS. 4 and 6). The DIC technique is ideally suited to detect small phase defects in a mask blank that may affect printing on a wafer in EUV lithography.

In operation, the light source 202 in FIG. 2A generates a beam or ray of light. The beam passes through the isolator 204, is reflected by the mirror 206 and passes through the half wave plate 208 and the beam splitter 210 as beam 236 to the Wollaston prism 218. The Wollaston prism 218 in FIG. 2A splits the incoming light beam 236 into two beams with different polarizations (see FIG. 2B), which become the light beams 242, 244 incident on the surface 241. The Wollaston prism 218 is described further below with reference to FIG. 2B.

After the Wollaston prism 218, the two beams enter a number of optical elements 220, 222, 224, 226, 228 and are reflected by two mirrors 230, 232. The incident beams 242, 244 in FIG. 2A are projected onto the surface 241 of the object 240 with a substantially normal incidence.

The surface 241 of the object 240 reflects some or all of the incident beams 242, 244 back to the mirror 232. The two reflected beams (shown jointly with incident beams 242, 244 in FIG. 2A) travel back along the same optical paths but in an opposite direction as the incident beams 242, 244. The mirrors 232, 230 reflect the two reflected beams, which travel back through the optical elements 228, 226, 224, 222, 220, the Wollaston prism 218, and the beam splitter 210.

The Wollaston prism 218 recombines the two reflected beams, and the beam splitter 210 directs the recombined reflected beam to the polarizing beam splitter 212. The polarizing beam splitter 212 (which may be rotated 45 degrees) splits the reflected beams to be measured by the two bright field detectors 214, 216. The detectors 214, 216 may form a phase difference, bright field channel.

In another embodiment, the radiation reflected from the surface 241 does not follow the same but opposite optical paths as the beams 242, 244. For example, the system 100 in FIG. 1 or a modified system based on the system of FIG. 1 may be configured to use the DIC technique described herein. In this embodiment of the system, optical elements, such as reflectors, beam splitters and/or lenses, may direct reflected radiation along optical paths that are different than the optical paths of the incident beams to detectors that detect and measure the reflected radiation. The detectors may be positioned at any suitable location. For example, in reference to FIG. 1, two substantially parallel beams instead of one beam 108 are directed along an oblique angle to surface of the sample, and the reflected beams along paths 114 are directed to two separate Wollaston prisms instead of one such prism. Other than such difference, such system functions essentially in the same manner as the embodiment of FIGS. 2A, 2B.

FIG. 2B illustrates a subset of the components in FIG. 2A and some additional components. FIG. 2B illustrates a half wave plate 252, a polarizing beam splitter 250, another half wave plate 208, another polarizing beam splitter 210, a Wollaston prism 218, a lens or lens assembly 270 (for example, lenses 220, 224, 226, 228 in FIG. 2A), another polarizing beam splitter 212, two lenses 213, 215, two detectors 214, 216 and a signal processor 260.

As one of ordinary skill in the art would appreciate, the Wollaston prism 218 in FIGS. 2A and 2B comprises two orthogonal prisms 219A, 219B formed from a material such as calcite, which may be held or cemented together. The optical axis of one prism 219A is perpendicular to the optical axis of the other prism 219B, and both optical axes are perpendicular to the direction of propagation of the incident light 236.

As described above, the Wollaston prism 218 splits the incoming light beam 236 into two beams 242, 244, which may be called an ordinary ray and an extraordinary ray, with different polarizations (defined with respect to the optical axes of the prism 218). The two beams 242, 244 have two mutually-perpendicular (orthogonal) polarizations, which may be denoted as “p” and “s.” The symbol “p” represents polarization in one direction, and “s” represents polarization in another direction. In one embodiment, the two beams 242 (p-polarized), 244 (s-polarized) in FIGS. 2A and 2B from the Wollaston prism 218 are coherent. In one embodiment, the two beams 242, 244 have different directions, the same frequency, the same intensity and a fixed phase relationship.

The distance between a center of one incident beam 242 and a center of the other incident beam 244 in FIGS. 2A and 2B may be referred to as p-s separation. The p-s separation may be configurable by modifying the position or structure of one or more components of the system 200. For example, the_p-s_separation may be about 0.5 to about 10 microns. The p-s separation may also be referred to as a diameter of an inspected area on the surface 241 (FIG. 2A).

The Wollaston prism 218 also recombines two beams reflected from the surface 241 into a single recombined, reflected beam. The irradiance (or intensity) of the two reflected beams that pass through the Wollaston prism 218 may be expressed as Iₚ and Iₛ. In one embodiment, Iₚ/Iₛ=1. In another embodiment, Iₚ/Iₛ=25/1. In other embodiments, other ratios of Iₚ/Iₛ are used.

The polarizing beam splitter 210 may be a fixed-ratio PBS. The polarizing beam splitter 210 directs the recombined, reflected beam from the Wollaston prism 218 to the polarizing beam splitter 212, which may be rotated 45 degrees with respect to the axes of prism 218.

The two light beams 242, 244 or light waves from the Wollaston prism 218 are associated with two vectorized electric fields incident on the surface 241, which may be expressed as:

\vec{E}ₓ=Aexp[j(ωt+βₓ)]\hat{x}

\vec{E}_{y}=Bexp[j(ωt+β_{y})]ŷ

where “A” and “B” represent amplitudes, “ω” represents the angular frequency, “t” represents a point in time, x being along the p direction, y the s direction, and “βₓ” and “β_{y}” represent two phase shifts caused by the Wollaston prism 218.

The physical characteristics of the Wollaston prism 218, such as the size, dimensions, orientation of optical axes and configuration of the prisms 219A, 219B, may be modified to change the p-s or the x-y separation, the phase shifts βₓ and β_{y} of the beams 242, 244 and other characteristics of the beams 242, 244. In addition, other components of the system 200 in FIG. 2A may be modified to change the x-y separation, the phase shifts βₓ and β_{y} of the beams 242, 244 and other characteristics of the beams 242, 244.

The two beams 242, 244 in FIG. 2B are incident on two spots 610, 612 (see FIG. 6) on the surface 241, but the spots 610, 612 may spatially overlap an area on the surface 241. After the beams 242, 244 are reflected by the surface 241, the beams 242, 244 are associated with two vectorized electric fields, which may be expressed as:

$${\vec{E}}_{x}^{′} = A exp [ j ( ω t + {β}_{x} + {φ}_{x} ) ] \hat{x}$$

$${\vec{E}}_{y}^{′} = B exp [ j ( ω t + {β}_{y} + {φ}_{y} ) ] \hat{y}$$

$$Δ φ = {φ}_{y} - {φ}_{x} = \frac{2 π}{λ} \cdot 2 ( Δ h )$$

where φₓ and φ_{y} represent phase shifts due to reflection from the surface 241. The phases and other characteristics of the two reflected beams may be measured by the detectors 214, 216 in FIGS. 2A and 2B. As shown in the last equation above, the difference in phase shifts (αφ=φ_{y}−φₓ) caused by the reflection of the beams 242, 244 on two different spots 610, 612 (FIG. 6) on the surface 241 is proportional to the difference in surface height (Δh) of the two spots 610, 612 (see FIGS. 4 and 6).

“λ” in the last equation above represents the wavelength of the reflected light beams. In one embodiment, λ has a value of about 257 nanometers. Other values of λ may be used in other embodiments.

The intensity or irradiance of the two beams with interference may be expressed as:

I=|Eₓ′+E_{y}′|²=A²+B²+2AB cos(φ_{y}−φₓ)

where β_{y}-βₓ is zero. Thus, in this instance, the intensity of the two reflected beams varies according to the difference in phase shifts (φ_{y}−φₓ) caused by the reflection of the beams 242, 244 on two different spots 610, 612 (FIG. 6) on the surface 241.

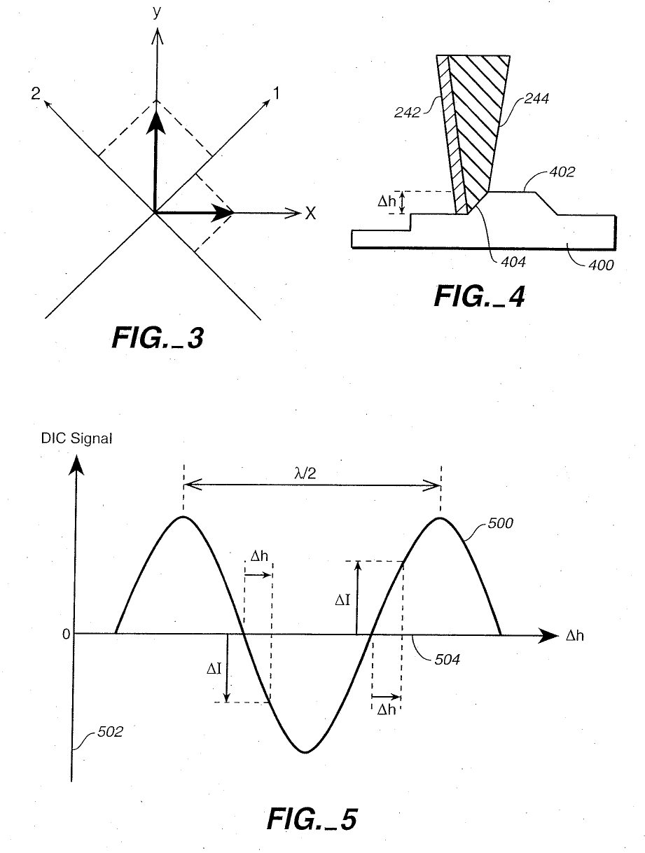

FIG. 3 illustrates a vector graph of outputs of the polarizing beam splitter 212 (with axes 1 and 2 as shown in FIG. 3) in FIGS. 2A and 2B, which is oriented at 45 degrees with respect to axes of prism 218 (shown as X and Y axes in FIG. 3). According to FIG. 3, the two beams 254, 256 (FIG. 2B) leaving the polarizing beam splitter 212 may be expressed as:

E₁=(Eₓ′+E_{y}′)cos 45°

E₂=(E_{y}′−Eₓ′)cos 45°

The signal outputs (S1, S2) of the two detectors 214, 216 in FIG. 2B may be expressed as:

S₁, which is proportional to A²+B²+2AB cos(Δβ+Δφ);

S₂, which is proportional to A²+B²−2AB cos(Δβ+Δφ).

Where Δβ is the difference in phase shift experienced by beams 242, 244, or the difference between βₓ and β_{y} caused by the Wollaston prism.

The detectors 214, 216 transfer signals to the signal processor 260, which is coupled to the detectors 214, 216.

The signal processor 260 in FIGS. 2A and 2B may comprise an analog-to-digital converter configured to convert analog signals from the detectors 214, 216 to digital signals for processing. The signal processor 260 may be implemented on a circuit board, which may be coupled to a display device 262. The signal processor 260 is configured to analyze the intensity and/or phase of the two beams 254, 256. In other embodiments, the signal processor 260 is configured to analyze other characteristics of the two beams 254, 256. In one embodiment, the signal processor 260 processes the signal outputs S₁, S₂ of the two detectors 214, 216 to produce a differential interference contrast (DIC) signal strength S_{DIC} and a summation signal strength S_{SUM}:

S_{DIC}=S₁−S₂=4AB cos(Δβ+Δφ), in which common mode noise is removed;

S_{SUM}=S₁S₂=2(A²+B²), which measures reflectivity.

If the Wollaston prism 218 is configured such that the phase difference Δβ=π/2, then:

S_{DIC}=4AB sin(Δφ)≅4ABΔφ, which is a bipolar DIC signal, when Δφ is small.

FIG. 4 illustrates an example of two beams 242, 244 scanning a surface 402 of an object 400 that has a change in height (i.e., slope) expressed as Δh.

FIG. 5 illustrates a plot 500 of surface height change (Δh) on the x-axis 504 and DIC signal strength intensity change (ΔI or S_{DIC}) on the y-axis 502. The signal processor 260 in FIGS. 2A and 2B uses the DIC technique to generate the plot 500 in FIG. 5 and determine the surface variations of the object 400 in FIG. 4. As shown in FIG. 5, the DIC technique measures tangential slope, i.e., ΔI/Δh. In one embodiment, the system 200 in FIG. 2A is sufficiently sensitive to detect surface height changes (Ah) of about 32.125 nanometers (λ/8=257/8=32.125) or smaller. In another embodiment, the system 200 with a smaller scanning spot size caused by optics and/or a different objective may detect a surface defect of about 60 nm in diameter and about 1.5 nm high on a mask blank. In other embodiments, the system 200 in FIG. 2A may detect other ranges of surface height changes (Ah). In one embodiment, the system 200 is sufficiently sensitive to capture about 100% of the surface height variations of a mask blank.

FIG. 6 illustrates a Wollaston prism 218 in the system 200 of FIG. 2A that generates beams of light 242, 244 to detect examples of height variations 614-622, i.e., defects, on a surface 640 of an object 600. The Wollaston prism 218 in FIG. 6 splits a beam 236 into two beams 242, 244, which are incident on two spots 610, 612 on the surface 640. FIG. 6 is an abbreviated schematic of FIGS. 2A and 2B, where light beams split by the Wollaston prism 218 are directed by one or more lenses to have a substantially normal incidence with respect to five different surface structures at locations A, B, C, D, E on the object 240. The spots 610, 612 in FIG. 6 may spatially overlap an area on the surface 640. The spots 610, 612 reflect beams back to the Wollaston prism 218 and to the system 200 of FIG. 2A. The object 600 or the beams 242, 244 may be moved horizontally, e.g., to the left or to the right, for the beams 242, 244 and the spots 610, 612 to scan the surface 640 for height variations 614-622.

Although the defects 614-622 in FIG. 6 have distinct shapes and edges, the system 200 in FIG. 2A can detect and measure very small defects such as bumps or dimples that are approximately 0.5 micron in size or smaller.

The signal processor 260 of FIG. 2A uses DIC and signal processing to detect and measure phase differences of the reflected beams, which determine the characteristics of the surface height variations 614-622. The signal processor 260 of FIG. 2A may generate signal plots 630, 632, 634 (FIG. 6) on a graph 650 to characterize the surface height variations 614-622. The x-axis of the graph 650 represents time, and the y-axis of the graph 650 represents a DIC signal strength (ΔI or S_{DIC}) of the reflected beams.

For example, the surface height variations 614-622 in FIG. 6 may be characterized as positive defects with a positive Δh (e.g., bumps, mounds or step-up slip lines) or as negative defects with a negative Δh (e.g., dimples, pits, step-down slip lines). In one configuration, the processor 260 in FIG. 2A stores two threshold values for ΔI (FIG. 5). If ΔI is above a first threshold value, then a detected defect is classified as positive. If ΔI is below a second threshold value, then a detected defect is classified as negative.

As another example, the surface height variations 614-622 in FIG. 6 may be characterized as bipolar defects (e.g., bumps, mounds, dimples, pits) or unipolar defects (e.g., slip lines). In one embodiment, the processor 260 (FIG. 2A) classifies a defect as a bipolar defect if a positive unipolar defect and a negative unipolar defect are within a pre-determined proximity (e.g., 30-50 micrometers) of each other. Polarity may be determined by the polarity of a defect that is first encountered along a scan direction. The processor 260 may classify a defect as a “large point defect” if several bipolar defects are within a pre-determined proximity of each other.

Furthermore, the surface height variations 614, 616 in FIG. 6 may be classified as convex. The surface height variation 618 may be classified as a step. The surface height variations 620, 622 may be classified as concave.

In one embodiment, the signal processor 260 maps and displays signal plots of surface height variations on a monitor 262 and/or save to a file in a memory.

The above scheme illustrated in FIGS. 1-6 may be modified by using a Wollaston prism separate from prism 218 to combine the two transmitted beams.

As alternatives to the embodiments described above, the interferometers described in U.S. Pat. No. 6,687,008 (which is incorporated herein in its entirety by reference) may also be used for measuring a mask blank. U.S. Pat. No. 6,687,008 is incorporated herein in its entirety by reference. The present invention improves upon prior systems by employing waveguided optics and an optical coupler which we refer to as a tri-coupler. The tri-coupler consists of three waveguide inputs and three waveguide outputs and a region in between in which the waves from each of the three inputs are redistributed approximately equally to each of the three outputs. If one assumes that the tri-coupler is lossless and distributes light from an input waveguide equally to each of the three output waveguides, then it is possible to prove that there must be a 120 degree phase shift between each of the three output light waves. As a consequence of this, if light is injected into two of the input waveguides, then the intensity of the light in the three output waveguides will possess a periodic interferometric modulation as the phase difference between the input beams is advanced, and in particular, the phase relation among the intensities of these three beams will be 120 degrees. Because of this, it is possible to measure the intensities of the three output beams, and accurately determine the phase difference between the two input beams. In addition, the total intensity of the input light can also be calculated.

Because the three output intensities are phase-separated by 120 degrees, the interferometer of the present invention has no point of null sensitivity. Furthermore, this advantageous phase relation is achieved using only one input polarization state; there is no need to create separate orthogonally polarized beams in order to obtain quadrature signals or the advantages thereof. A well made tri-coupler will produce the desired 120 degree phase relation with any polarization input. This leads to a further advantage of the tri-coupler interferometer which is its simplicity and compactness. As mentioned above, the advantageous 120 degree phase relation is created without the use of polarizing beamsplitters or additional phase shifters, so the number of optical components required is significantly reduced. This greatly reduces the cost of the system. In addition, an optical tri-coupler is quite compact (typically measuring 0.12″ diameter by 2″ in length), and requires no alignments or adjustments in order to produce the desired interferometric properties.

In this application, the terms “light” and “electromagnetic radiation” are used interchangeably. One alternative embodiment of the present invention is to measure the height variation and/or other features of the mask blank affecting phase of the beams from an optical interferometer by means of a ti-coupler in which each of the two light waves to be phase-compared are injected into a separate input waveguide of the tri-coupler (the third input waveguide receives no input signal), and the output waveguides are fed to detectors which record the intensity of the three outputs. These intensity readings are then fed to a computing device which accurately calculates the phase difference between the input beams. The calculation includes certain calibration routines described below which allow the slight imperfections and nonuniformities in the coupler, waveguides, and detectors to be accounted for during the calculation thereby increasing the accuracy of the measurement.

A multiphase interferometer will provide several outputs. This is generated by a measuring optical beam that is multiply split and interferes with a corresponding number of reference beams. Each output signal then depends on the phase of the measured beam as well as the phase of the corresponding reference beam. For best accuracy, these reference beam phases need to be known as precisely as possible. For this case, a calibration is required where the relative phase of signal to reference beam is wound through 360 degrees and the output signals are recorded. A device that changes the beam path length or one that changes the index of refraction of a beam path can accomplish this. Output signal are recorded as the phase is wound. This forms a calibration data set and can then be processed by a wide variety of numerical or mathematical means to obtain the accurate phase for the reference signals.

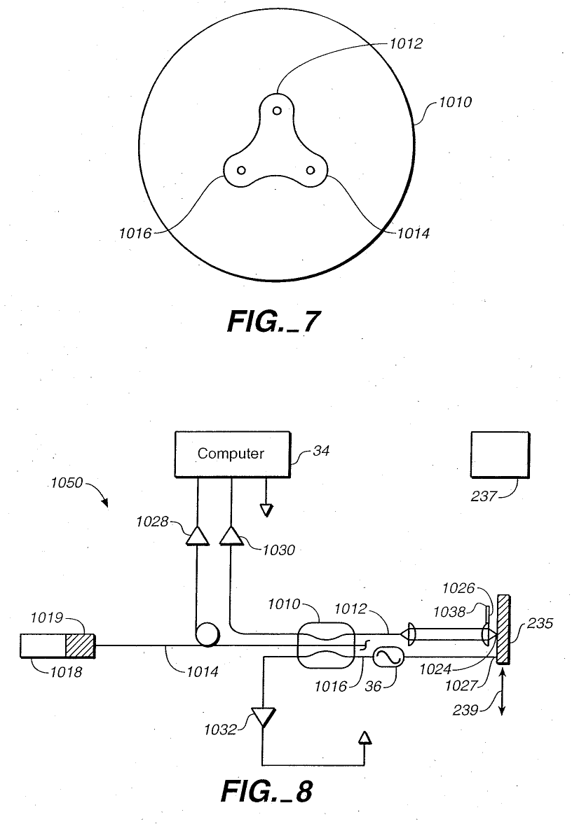

Referring to the drawings more particularly by reference numbers, FIG. 7 is a schematic cross section through one section of a fused-fiber optical tri-coupler 1010 showing the spatial symmetry of the three fibers 1012, 1014 and 1016 which lead to the characteristic 120 degree phase relation between the light waves within each of the three waveguides. The tri-coupler 1010 couples light between the first 1012, second 1014 and third 1016 waveguides such that light input at one end of any waveguide is substantially equally distributed to each of the three waveguides at the output end.

FIG. 8 shows an embodiment of an optical interferometer 1050 of the present invention. The interferometer 1050 may include a first waveguide 1012, a second waveguide 1014 and a third waveguide 1016. The waveguides may be fiberoptic cables or integrated waveguides that transmit light.

In this embodiment, one of the waveguides, which for concreteness is call the second waveguide 1014, may be coupled to a laser light source 1018. By way of example, the light source 1018 may be a laser. The light source 1018 may have a return isolator 1019 that prevents back reflections from feeding back into the source 1018. The light emitted from the light source 1018 and isolator 1019 may be directed into the tri-coupler 1010 via an optical circulator 1022.

Light entering the tri-coupler 1010 along waveguide 1014 is distributed to each of the three output waveguides 1012, 1014 and 1016 in roughly equal intensities. Light exiting the tri-coupler on waveguide 1014 is allowed to escape the waveguide unused, and the waveguide is terminated in such a way that minimal light is reflected back into the tri-coupler. The light exiting the first waveguide 1012 is reflected from a first area 1024 of an object surface (such as that of a mask blank) back into the waveguide 1012. The interferometer 1050 may include a lens assembly 1026 and an autofocus system 1038 which focuses the light onto area 1024 and back into waveguide 1012. Light within the third waveguide 16 may be reflected from a second area 1027 of the object surface back into the waveguide 1016.

In one embodiment, the object is a mask blank with surface areas 1024 and 1027, which object is held in a frame 235 at inspection station shown in FIG. 8. A handler or gripper 237 moves the mask blank by gripping frame 235 and moving the frame along arrow 239 towards the inspection station where the mask blank is positioned as shown in FIG. 8 for inspection as described herein. After inspection is completed, handler or gripper 237 moves the frame and mask blank therein away from the station. The handler or gripper 237 is available commercially, and may be controlled to operate as described above in a conventional manner known to those skilled in the art.

The light reflected from the areas 1024 and 1027 through the first 1012 and third 1016 waveguides travels back through the ti-coupler 1010. The reflected light within the first waveguide 1012 provides a first beam. The light within the third waveguide 1016 provides a second beam that interferes with the first beam within the tri-coupler 1010.

The tri-coupler 1010 will allow reflected light within the first waveguide 1012 to be coupled into the second 1014 and third 1016 waveguides, and reflected light from the third waveguide 1016 to be coupled into the first 1012 and second 1014 waveguides. The output of the tri-coupler 1010 is three light beams with intensities that are out of phase with each other by approximately 120 degrees. The light intensity of each light beam is detected by photodetectors 1028, 1030, and 1032. The light exiting the tri-coupler 1010 along waveguide 1014 is directed to the detector 1028 via the circulator 1022.

The photodetectors 1028, 1030, and 1032 provide electrical output signals to the computer 1034. The computer 1034 may have one or more analog to digital converters, processor, memory etc. that can process the output signals.

By way of example, the interferometer 1050 can be used to infer the surface profile of a mask blank. The height at any point can be inferred from the following equation.

h=θ/(4·π·λ)

where:

h=the apparent height;

θ=the interferometric phase angle between the object and reference beams, and

λ=the wavelength of the reflected light.

The interferometric phase angle can be determined by solving the following three equations.

I1=α1·(E1²+(β1·E2)²+2β1·E1·E2·cos(θ−Ø1))

I2=α2·(E1²+(β2·E2)²+2β2·E1·E2·cos(θ−Ø2))

I3=α3·(E1²+(β3·E2)²+2β3·E1·E2·cos(θ−Ø3))

where:
I1=the light intensity measured by the photodetector 30;
I2=the light intensity measured by the photodetector 32;
I3=the light intensity measured by the photodetector 28;
E1=the optical field of the light reflected from the test surface into the first waveguide 12;
E2=the optical field of the light reflected from the reference surface into the third waveguide 16;
Ø1=the phase shift of the detected light within the first waveguide, this may be approximately −120 degrees;
Ø2=the phase shift of the detected light within the second waveguide, this may be defined to be 0 degrees;
Å3=the phase shift of the detected light within the third waveguide, this may be approximately +120 degrees;
α1=a channel scaling factor for the first waveguide and detector;
α2=a channel scaling factor for the second waveguide and detector;
α3=a channel scaling factor for the third waveguide and detector;
β1=a coupler nonideality correction term for channel 1;
β2=a coupler nonideality correction term for channel 2, and
β3=a coupler nonideality correction term for channel 3.

The interferometer 1050 may include a phase shifter 1036 that shifts the phase of the light within the third waveguide 1016. The phase shifter 1036 may be an electro-optic device that can change the phase to obtain a number of calibration data points. The calibration data can be used to solve for the phase shift values Ø1, and θ3, the channel scaling factors α1, α2, and α3, and the coupler nonideality factors β1, β2, and β3. The values are stored by the computer 1034 and together with the measured light intensities I1, I2, and I3 are used to solve equations 1, 2, 3, and 4 to compute the phase angle and the apparent height h.

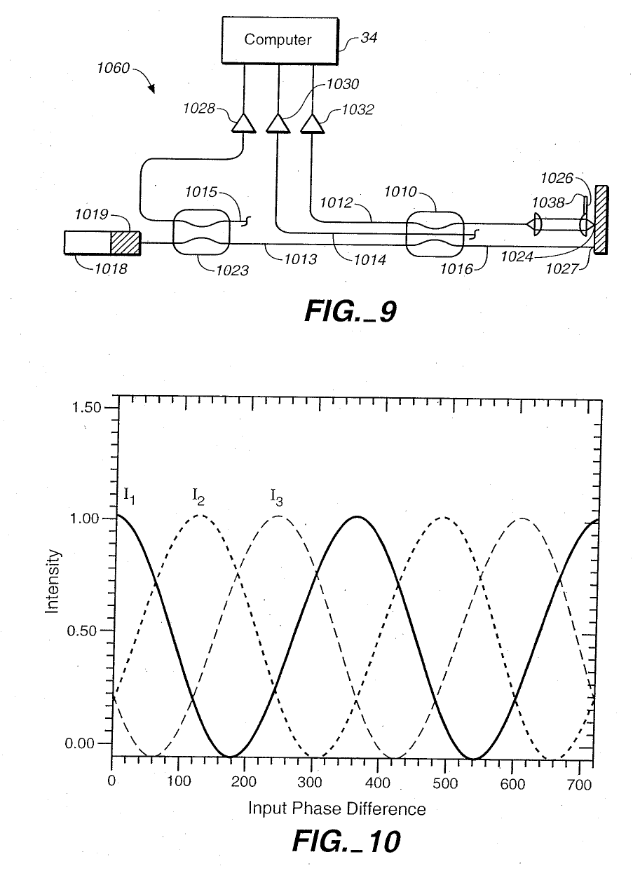

FIG. 9 shows an alternate embodiment of an optical interferometer 1060 of the present invention. The interferometer 1060 uses a 2×2 optical coupler 1023 in place of the circulator 1022 used in interferometer 1050. In this case, light from the laser 1018 is split as it passes forward through coupler 1023. Light exiting coupler 1023 along waveguide 1015 is dumped. Light exiting coupler 1023 in waveguide 1013 is fed into tri-coupler 1010 as in the interferometer 1050 previously discussed. Light returning from tri-coupler 1010 along waveguide 1013 is split. Light exiting coupler 1023 along, waveguide 1013 is rejected by isolator 1019 and does not interfere with the laser. Light exiting coupler 1023 along waveguide 1015 is fed to detector 1028. This embodiment of interferometer 1060 is less expensive than that of interferometer 1050 owing to the fact that coupler 1023 is considerably less expensive than circulator 1022. However, the laser power delivered into the tri-coupler 1010 is reduced and the signal detected by detector 1028 is also reduced as compared to those detected in detectors 1030 and 1032. In some applications, these facts are inconsequential and the reduced cost of interferometer 1060 is preferable. As in the embodiment of FIG. 8, the object may be a mask blank with surface areas 1024 and 1027, which object may be in a frame at an inspection station in FIG. 9. A handler or gripper moves the mask blank by gripping the frame and moving the frame in a manner similar to that described above in reference to FIG. 8. For simplicity, these components have been omitted from FIG. 9.

The output signals of the photodetectors 1028, 1030, and 1032, responding to a steadily advancing phase angle at the inputs, are shown superimposed in FIG. 10. The phase shifts between different light beams separates the maxima and minima of the output signals. With such an arrangement at least one of the signals will be in a relatively sensitive portion of the waveform between a maximum and minimum. In this simple way, it can be seen why the present invention provides an interferometric detector that has a relatively uniform sensitivity and is therefore desirable for meteorological applications.

Interferometers 1050 and 1060 of the present invention provide three out-of-phase signals with a minimal number of parts. The tri-coupler 1010 and fiberoptic waveguides 1012, 1014, and 1016 can be packaged into a relatively small unit, typically measuring only 0.12″ diameter by 2″ in length. This reduces the size, weight and cost of the interferometers. By way of example, the tri-coupler 1010 and waveguides 1012, 1014, and 1016 could be also constructed onto a single planar substrate using known photolithographic and waveguide fabrication techniques. Such a construction method would have advantageous properties which would allow tighter integration with other portions of the interferometric system together with reduced assembly costs.

While embodiments of FIGS. 7-10 employ a tri-coupler, it will be understood that a coupler that mixes two inputs and provides more than three outputs may be used, such as a four way coupler, which mixes two inputs and provides four outputs that are separated by 90 degrees in phase between any two adjacent outputs. The construction and equations characterizing the four way or higher order couplers are similar to those described and shown above for the tri-coupler, and may be used in lieu of the tri-coupler to obtain the advantages described in connection with the tri-coupler. The construction and equations that characterize such couplers are believed to be evident to those skilled in the art in view of the examples described above. For this reason, they have been omitted here. The concept can be extended to more than four way coupling, or N way coupling, where N is an integer greater than 2, and where outputs of the N way coupler are separated by 360/N degrees in phase between any two adjacent outputs. Couplers that mixes two or more inputs to provide three or more outputs are referred to in this application as a multiple way coupler; all such couplers are within the scope of this invention.

Although an interferometer for measuring an object such as a mask blank is described, it is to be understood that the present invention can be used for other interferometric measurements which seek to determine the phase relation between two input waves.

While the invention has been illustrated by embodiments where the detection subsystem detects portions of the incident beams reflected by surface of the mask blank, it will be understood that a slightly modified detection scheme, but employing the same equations as those set forth above, can also be used for the detection of portions of the incident beams transmitted by the mask blank. While the invention has been described above by reference to various embodiments, it will be understood that changes and modifications may be made without departing from the scope of the invention, which is to be defined only by the appended claims and their equivalents. For example, in the embodiments of FIGS. 7-10, although the light reflected from the test area 24 is initially directed through the tri-coupler 1010, it is to be understood that the light can be introduced to the test area 1024 without initially traveling through the coupler 1010. All references referred to herein are incorporated by reference in their entireties.

1. A system for detecting height variation or other features on a mask blank, comprising:
an interferometer transmitting to said mask blank two substantially parallel optical incident radiation beams, said interferometer comprising a multiple way coupler that mixes portions of the two beams reflected or transmitted by two different areas of said mask blank to provide three or more outputs;
an instrument handling and transporting the mask blank to and from an inspection station; and
multiple detectors detecting the three or more outputs to provides three or more signals.

2. The system of claim 1, further comprising a device that derives from the three or more signals any phase shift between the reflected or transmitted portions of the two incident beams to determine height variation on the mask blank.

3. The system of claim 1, said instrument comprising a frame holding the mask blank.

4. The system of claim 1, said instrument comprising a handler or gripper.

5. The system of claim 1, wherein said two beams are incident on a surface of the mask blank in directions substantially normal to the surface.

6. The system of claim 1, wherein said two incident radiation beams are coherent with each other with a predetermined phase relationship there between.

7. The system of claim 1, said multiple way coupler comprising a tri-coupler.

8. The system of claim 7, said interferometer comprising:
a first waveguide that guides to the tri-coupler the portion of the beam reflected from or transmitted by a first area of the mask blank; and
a second waveguide that guides to the tri-coupler the portion of the beam reflected from or transmitted by a second area of the mask blank;
wherein said tri-coupler mixes the reflected or transmitted radiation within said first and second waveguides to provide three outputs.

9. The system of claim 8, said interferometer further comprising a source that supplies radiation to the tri-coupler so that the tri-coupler provides the two incident beams.

10. The system of claim 9, said interferometer further comprising a third waveguide supplying radiation from the source to the tri-coupler, said three waveguides receiving the three outputs of the tri-coupler.

11. An apparatus that can measure optical phase variations in or along a mask blank, comprising:
a source that emits electromagnetic radiation;
a first waveguide that guides electromagnetic radiation reflected from or transmitted by a first area of the mask blank;
a second waveguide that guides electromagnetic radiation;
a third waveguide that guides electromagnetic radiation reflected from or transmitted by a second area of the mask blank;
a tri-coupler that mixes the reflected or transmitted electromagnetic radiation within said first and third waveguides and provides a first output beam within said first waveguide, a second output beam within said second waveguide, and a third output beam within said third waveguide;
a first photodetector that detects the first output beam and generates a first output signal;
a second photodetector that detects the second output beam and generates a second output signal;
a third photodetector that detects the third output beam and generates a third output signal; and
a controller that receives said first, second, and third output signals and computes the phase difference between the first and third input beams.

12. The apparatus of claim 11, wherein electromagnetic radiation intensities of the first, second, and third output light beams are approximately 120 degrees out of phase.

13. The apparatus of claim 11, further comprising a phase shifter coupled to said third waveguide.

14. The apparatus of claim 11, wherein said first, second, and third waveguides each includes a fiberoptic cable.

15. The apparatus of claim 11 wherein said phase difference is used to estimate the height and/or reflectivity of surface features on the mask blank.

16. A method for detecting height variation or other features on a mask blank, comprising:
transmitting to said mask blank two substantially parallel optical incident radiation beams;
mixing portions of the two beams reflected or transmitted by two different areas of said mask blank to provide three or more outputs;
detecting the three or more outputs to provide three or more signals.

17. The method of claim 16, further comprising handling and transporting the mask blank to and from an inspection station.

18. The method of claim 16, further comprising deriving from the three or more signals any phase shift between the reflected or transmitted portions of the two incident beams to determine height variation on the mask blank.

19. The method of claim 16, wherein said two beams are transmitted so that they are incident on a surface of the mask blank in directions substantially normal to the surface.

20. The method of claim 16, wherein said two incident radiation beams are transmitted so that they are coherent with each other with a predetermined phase relationship there between.

21. The method of claim 16, wherein said transmitting and mixing comprise coupling a first radiation beam from a first waveguide to a second waveguide and a third waveguide, and a second radiation beam from the third waveguide to the first and second waveguides to create a first output radiation beam in the first waveguide, a second output radiation beam in the second waveguide, and a third output radiation beam in the third waveguide.

22. The method of claim 21, wherein intensities of the first, second, and third output radiation beams have light intensities that are approximately 120 degrees out of phase.

23. The method of claim 16, further comprising computing a phase angle from the detected three or more signals.
